(19) United States
(12) Patent Application Publication
(10) Pub. No.: US 2026/0071286 A1
(43) Pub. Date: Mar. 12, 2026

(54) METHOD OF PRODUCING HOT METAL USING SOLID-REDUCING FURNACE AND SUBMERGED ARC FURNACE

(71) Applicant: JFE STEEL CORPORATION, Chiyoda-ku, Tokyo (JP)

(72) Inventors: Yuji IWAMI, Chiyoda-ku, Tokyo (JP); Takahide HIGUCHI, Chiyoda-ku, Tokyo (JP); Kenta TAKEHARA, Chiyoda-ku, Tokyo (JP); Kenya HORITA, Chiyoda-ku, Tokyo (JP); Naoto NAKAMURA, Chiyoda-ku, Tokyo (JP); Shohei FUJIWARA, Chiyoda-ku, Tokyo (JP)

(73) Assignee: JFE STEEL CORPORATION, Chiyoda-ku, Tokyo (JP)

(21) Appl. No.: 19/107,576

(22) PCT Filed: Jul. 11, 2023
(86) PCT No.: PCT/JP2023/025630

§ 371 Date: Feb. 28, 2025

(30) Foreign Application Priority Data
Sep. 21, 2022 (JP) 2022-150752

(51) Int. Cl. C21B 11/10; C22B 9/20; F27B 3/08

(52) U.S. Cl. CPC C21B 11/10; C22B 9/20; F27B 3/085

(57) ABSTRACT

Provided is a method of producing hot metal that can achieve high energy efficiency in the melting process when producing reduced iron from iron ore in a solid-reducing furnace and melting the reduced iron in an SAF to produce hot metal. The method of producing hot metal includes: a process of producing first reduced iron from low-grade iron ore pellets, an optional process of producing second reduced iron from high-grade iron ore pellets, an optional process of producing third reduced iron from lump ore, and an optional process of preparing fourth reduced iron; and a process of melting the first to fourth reduced iron in the SAF and adding flux to adjust basicity, and satisfies the following Expression as described in the description: 150.0≤S1×W1+S2×W2+S3≤400.0.

### TECHNICAL FIELD

The present disclosure relates to a method of producing hot metal using a solid-reducing furnace and a submerged arc furnace.

### BACKGROUND

In response to recent public opinion on CO₂ emission reduction, the iron and steel industry, which has a large CO₂ emission volume, has been focusing on the direct reduction (DR) method as a method of producing pig iron that does not require the blast furnace method, in order to reduce environmental impact. In the DR method, iron ore material such as iron ore pellets and lump ore is first reduced, in a solid state, by gas reduction in a solid-reducing furnace (shaft furnace) to produce direct reduced iron (DRI, hereinafter also referred to simply as “reduced iron”). The reduced iron is melted in an electric arc furnace (EAF), a submerged arc furnace (SAF), or other melting furnace to obtain hot metal with the pig iron slag (molten slag) separated.

Iron ore pellets as iron ore material used in the DR method are produced by mixing and granulating fine ore with a binder and an auxiliary material to obtain green pellets, and then firing the green pellets. Bentonite is often used as a binder.

According to Patent Literature (PTL) 1, a two-layer pellet structure is proposed, consisting of a porous body made of iron ore material and a coating layer that coats the porous body. The coating layer contains a Ca compound, an Fe compound, and 0.1 to 10.0 parts by mass of bentonite relative to the sum of the Ca compound and the Fe compound.

According to PTL 2, in order to improve pellet strength, use of smectite clay pretreated with a dispersant is proposed. Smectite clay contains bentonite, and examples are given in PTL 2 of smectite clay mix proportions in which 0.2 kg to about 1.0 kg, or about 0.4 kg to about 0.8 kg, or about 0.4 kg to about 0.7 kg of smectite clay is included per megatonne (MT) of pellet-forming particles.

### CITATION LIST

### Patent Literature

PTL 1: JP 2017-119910 A
PTL 2: JP 2021-507116 A

### SUMMARY

### Technical Problem

Conventionally, in the DR process, as apparatus for melting reduced iron, mainly electric arc furnaces (EAF) have been used. Due to apparatus constraints, EAF requires the use of high-quality reduced iron having a low slag ratio (high Fe content). Therefore, inevitably, high-grade iron ore has been used as the raw material for such reduced iron (that is, the feedstock ore for iron ore pellets). High-grade iron ore includes, for example, South American ores, concentrate ores that have been pre-beneficiated or otherwise upgraded, and pellet feed ores.

However, there are challenges in utilizing South American ores, concentrate ores, and pellet feed ores in Japan. Due to Japan's geographical location, freight rates for South American ore will inevitably rise. Concentrate ores and pellet feed ores are also often basically derived from high-grade iron ore because it is more efficient to beneficiate high-grade iron ore than low-grade iron ore, and for the same reason freight rates will increase. Therefore, the direct reduction process using high-grade iron ore has cost issues.

Accordingly, studies are underway in Japan to apply the DR method to low-grade iron ore produced in Australia, India, and other countries. According to current EAF, melt-processing reduced iron produced from low-grade iron ore is difficult. Therefore, the use of submerged arc furnaces (SAF) is being studied.

The melting process using an SAF requires a great deal of energy (electrical power), and therefore there is a demand for any improvement in energy efficiency. However, in a conventional series of hot metal production processes, which involves producing iron ore pellets from low-grade iron ore, reducing the iron ore pellets in a solid-reducing furnace to produce reduced iron, and melting the reduced iron in an SAF, no optimal raw material design guidelines have been obtained for achieving high energy efficiency.

According to PTL 1, iron ore pellets after firing are prone to being pulverized in a solid-reducing furnace, and therefore a goal was to suppress this reduction pulverization and secure strength of fired pellets. PTL 2 also aims to improve the strength of pellets. PTL 1 and 2 only consider the properties of pellets and do not take into account high energy efficiency in the series of hot metal production processes described above.

In view of the above, it would be helpful to provide a method of producing hot metal that can achieve high energy efficiency in the melting process when producing reduced iron from iron ore in a solid-reducing furnace and melting the reduced iron in a submerged arc furnace to produce hot metal.

### Solution to Problem

The inventors have conducted extensive studies to address the problem described above and have discovered that the energy efficiency in the melting process is higher when the total slag ratio in the melting process is in a defined range.

Primary features of the present disclosure are as follows.

[1] A method of producing hot metal, the method comprising: an iron ore preparation process (A) comprising a process (A-1) of preparing first iron ore pellets produced from low-grade iron ore having a total Fe content of 63 mass % or less, an optional process (A-2) of preparing second iron ore pellets produced from high-grade iron ore having a total Fe content exceeding 63 mass %, and an optional process (A-3) of preparing lump ore;
a reduced iron preparation process (B) comprising a process (B-1) of producing first reduced iron from the first iron ore pellets, an optional process (B-2) of producing second reduced iron from the second iron ore pellets, an optional process (B-3) of producing third reduced iron from the lump ore, and an optional process (B-4) of preparing a pre-produced fourth reduced iron; and
a melting process (C) of melting the first reduced iron and optionally any of the second reduced iron, the third reduced iron, and the fourth reduced iron in a submerged arc furnace to obtain hot metal, while adding flux to adjust basicity of molten slag formed on the hot metal, wherein the following Expression (1) is satisfied,

$$150. \leq S 1 \times W 1 + S 2 \times W 2 + S 3 \leq 400. \qquad ( 1 )$$

where
S1 is slag ratio, in kg/t, of the first reduced iron,
W1 is mix ratio of the first reduced iron,
S2 is average slag ratio, in kg/t, of the second, third, and fourth reduced iron,
W2 is total mix ratio of the second, third, and fourth reduced iron, and
S3 is amount of the flux, in kg/t, added in the melting process (C).

[2] The method of producing hot metal according to [1], wherein one or more selected from the group consisting of S1, W1, S2, W2, and S3 are intentionally set to satisfy Expression (1).

[3] The method of producing hot metal according to [2], wherein one or both of S1 and S3 are intentionally set to satisfy Expression (1).

[4] The method of producing hot metal according to [2] or [3], wherein the setting of S1 is performed by setting one or more conditions selected from composition of the low-grade iron ore used in the process (A-1) and type and mix ratio of binder and auxiliary material added in the process (A-1).

[5] The method of producing hot metal according to [1], further satisfying the following Expression (2)

$$250. \leq S 1 \times W 1 + S 2 \times W 2 + S 3 \leq 350. \qquad ( 2 )$$

[6] The method of producing hot metal according to [5], wherein one or more selected from the group consisting of S1, W1, S2, W2, and S3 are intentionally set to satisfy Expression (2).

[7] The method of producing hot metal according to [6], wherein one or both of S1 and S3 are intentionally set to satisfy Expression (2).

[8] The method of producing hot metal according to [6] or [7], wherein the setting of S1 is performed by setting one or more conditions selected from composition of the low-grade iron ore used in the process (A-1) and type and mix ratio of binder and auxiliary material added in the process (A-1).

[9] The method of producing hot metal according to any one of [1] to [8], wherein the flux is added so that the basicity, CaO/SiO₂, of the molten slag is from 1.0 to 1.3.

### Advantageous Effect

According to the method of producing hot metal, high energy efficiency can be achieved in the melting process when producing reduced iron from iron ore in a solid-reducing furnace and melting the reduced iron in a submerged arc furnace to produce hot metal.

### BRIEF DESCRIPTION OF THE DRAWINGS

In the accompanying drawings:

FIG. 1 is a graph illustrating the relationship between total slag ratio in a furnace and electrical power efficiency in a melting process.

### DETAILED DESCRIPTION

The following describes an embodiment of the method of producing hot metal using a solid-reducing furnace and a submerged arc furnace. The embodiment described below is an example embodiment of the present disclosure, and does not limit configuration to the specific example described.

The method of producing hot metal using a solid-reducing furnace and a submerged arc furnace according to an embodiment of the present disclosure includes: an iron ore preparation process (A) comprising a process (A-1) of preparing first iron ore pellets produced from low-grade iron ore having a total Fe content of 63 mass % or less, an optional process (A-2) of preparing second iron ore pellets produced from high-grade iron ore having a total Fe content exceeding 63 mass %, and an optional process (A-3) of preparing lump ore; a reduced iron preparation process (B) comprising a process (B-1) of producing first reduced iron from the first iron ore pellets, an optional process (B-2) of producing second reduced iron from the second iron ore pellets, an optional process (B-3) of producing third reduced iron from the lump ore, and an optional process (B-4) of preparing a pre-produced fourth reduced iron; and a melting process (C) of melting the first reduced iron and optionally any of the second reduced iron, the third reduced iron, and the fourth reduced iron in a submerged arc furnace to obtain hot metal, while adding flux to adjust basicity of molten slag formed on the hot metal. Further, the following Expression (1) is satisfied.

$$150. \leq S 1 \times W 1 + S 2 \times W 2 + S 3 \leq 400. \qquad ( 1 )$$

Here,
S1 is slag ratio, in kg/t, of the first reduced iron,
W1 is mix ratio of the first reduced iron,
S2 is average slag ratio, in kg/t, of the second, third, and fourth reduced iron,
W2 is total mix ratio of the second, third, and fourth reduced iron, and
S3 is amount of the flux, in kg/t, added in the melting process (C).

The raw material of iron ore pellets is typically iron ore, binder, and auxiliary material. Hereinafter, low-grade iron ore refers to iron ore having a total Fe content (hereinafter also referred to as T.Fe) of 63 mass % or less. Further, high-grade iron ore refers to iron ore having a T.Fe. exceeding 63 mass %. The low-grade iron ore preferably has a water of crystallization content of 4 mass % or more.

Iron ore pellets produced from low-grade iron ore are referred to as first iron ore pellets and iron ore pellets produced from high-grade iron ore are referred to as second iron ore pellets. The iron ore pellets used according to the present embodiment include at least the first iron ore pellets. When the first iron ore pellets are not included, slag weight, which is described below, is insufficient and energy efficiency is decreased. The iron ore pellets used according to the present embodiment may all be the first iron ore pellets, and may also include the second iron ore pellets.

Bentonite is a preferred binder for the iron ore pellets, but any known or optional binder may be used, including organic and inorganic binders that provide similar effects. Further, quicklime, limestone, dolomite, and the like may be mixed in as the auxiliary material.

The first iron ore pellets and the second iron ore pellets may be prepared by producing them through typical grinding, mixing, granulation, and firing processes. Pre-produced iron ore pellets may be prepared. When producing the iron ore pellets, each process may be carried out using conventionally known apparatus and conditions as listed below. The grinding process may be carried out using a typical ball mill or other grinder. The mixing process may be carried out using a typical high-speed agitator mixer, concrete mixer, or the like. The granulation process may be carried out using a typical pelletizer, drum mixer, or the like. The firing process may be carried out using a typical rotary kiln, electric furnace, or the like.

In addition to the iron ore pellets, lump ore may be prepared as a raw material for the reduced iron. Lump ore is iron ore, typically 10 mm to 35 mm in size, used in the reduction process without grinding.

In the reduced iron preparation process (B), reduced iron is produced from the first iron ore pellets as required raw material, and the second iron ore pellets and the lump ore as optional raw material. For the production of reduced iron, a solid-reducing furnace such as a typical shaft furnace may be used, and there are no particular restrictions on reducing gas. Depending on production method, for example, a mixed gas may be used that contains, in vol %, H₂: 55% and CO: 35%, with the balance being CO₂ and CH₄, or a mixed gas may be used that contains, in vol %, H₂: 75% and CO: 20%, with the balance being CO₂ and N₂. Reduced iron obtained from the first iron ore pellets, the second iron ore pellets, and the lump ore is referred to as first reduced iron, second reduced iron, and third reduced iron, respectively. Further, in addition to reduced iron obtained as described above, pre-produced reduced iron may be prepared, which is referred to as fourth reduced iron.

In the melting process, an SAF is used to melt each reduced iron prepared in the above process and separate into hot metal and molten slag formed on the hot metal. Furnace diameter of the SAF is preferably 5 m to 25 m. For example, an SAF having a production rate of 50 t/h corresponds to the above description. When the furnace diameter of the SAF is from 5 m to 25 m, the site area for furnace maintenance and apparatus is suitable.

In the melting process, flux is added to adjust the basicity of the molten slag formed on the hot metal. The basicity of the molten slag is calculated by the weight ratio of CaO/SiO₂. The basicity of the molten slag is preferably from 1.0 to 1.3. When the basicity of the molten slag is from 1.0 to 1.3, the molten slag is suitable for solidifying and grinding for reuse as cement or other roadbed material. The flux added to adjust the basicity of the molten slag is preferably, for example, limestone (CaCO₃) or quicklime (CaO) as a CaO source, and silica (SiO₂) as a SiO₂ source.

The total value, in kg, of CaO, SiO₂, Al₂O₃, and MgO per 1000 kg of total Fe content of the first reduced iron is the slag ratio S1, in kg/t. When multiple grades of low-grade iron ore are used as raw material, the average slag ratio is based on the mix ratio of each grade. Further, the mix ratio of the first reduced iron to the total molten reduced iron is W1.

The weighted average of the total value, in kg, of CaO, SiO₂, Al₂O₃, and MgO per 1000 kg of total Fe content of the second reduced iron, the total value, in kg, of CaO, SiO₂, Al₂O₃, and MgO per 1000 kg of total Fe content of the third reduced iron, and the total value, in kg, of CaO, SiO₂, Al₂O₃, and MgO per 1000 kg of total Fe content of the fourth reduced iron is taken as the average slag ratio S2, in kg/t. Further, the total mix ratio of the second, third, and fourth reduced iron to the total molten reduced iron is W2. The relationship W2=1−W1 holds true.

The total value, in kg, of CaO, SiO₂, Al₂O₃, and MgO in the added flux per 1000 kg of total Fe content of the hot metal in the melting process is S3, in kg/t.

S1 and S2 are determined from the sums of CaO, SiO₂, Al₂O₃, and MgO in the respective reduced iron raw material. The amount of various oxides can be measured by conventional methods such as titration, atomic absorption spectrometry, and fluorescence x-ray spectrometry.

According to the present embodiment, it is important that S1, W1, S2, W2, and S3 satisfy the following Expression (1). Here, “S1×W1+S2×W2+S3” is the total slag ratio per 1000 kg of total Fe content of the hot metal in the melting process, and hereinafter is also referred to as the “total slag ratio”.

$$150. \leq S 1 \times W 1 + S 2 \times W 2 + S 3 \leq 400. \qquad ( 1 )$$

When Expression (1) is satisfied, high energy efficiency is obtainable in the melting process. When Expression (1) is not satisfied and the total slag ratio exceeds 400.0 kg/t, there is excess slag and more energy is required for electrical resistance heating, and therefore the energy efficiency of the melting process is reduced. When Expression (1) is not satisfied and the total slag ratio is less than 150.0 kg/t, there is not enough slag and the electrode may slip through the layer of molten slag and dip into the molten steel, or the electrode may not reach the layer of molten slag. When the electrode is immersed in the molten steel, the current passage to the layer of the molten slag is decreased and therefore the efficiency of heating by electrical power is decreased. Further, when the electrode immersed in the molten steel is a self-baking electrode, there is a possibility of melting damage. On the other hand, when the electrode does not reach the layer of the molten slag, arcing and other problems occur, and electrical power use becomes unstable.

In order to satisfy Expression (1), preferably one or more selected from S1, W1, S2, W2, and S3 are intentionally set. Further, in order to satisfy Expression (1), more preferably one or both of S1 and S3 are intentionally set. This is because the usable amount of lump ore and pre-produced reduced iron is limited by the amount available on the market and value, and therefore S2 and W2 have a low degree of freedom in actual operations, and W1 (=1−W2) also has a low degree of freedom in actual operations as a result.

S1, W1, S2, W2, and S3 preferably satisfy the following Expression (2).

$$250. \leq S 1 \times W 1 + S 2 \times W 2 + S 3 \leq 350. \qquad ( 2 )$$

When Expression (2) is satisfied, energy efficiency is improved.

In order to satisfy Expression (2), preferably one or more selected from S1, W1, S2, W2, and S3 are intentionally set. Further, as above, in order to satisfy Expression (2), more preferably one or both of S1 and S3 are intentionally set.

S1 is preferably set by setting one or more conditions selected from composition of the low-grade iron ore used in the process (A-1) and type and mix ratio of the binder and the auxiliary material added in the process (A-1). S2 is preferably set by setting one or more conditions selected from composition of the high-grade iron ore used in the process (A-1), type and mix ratio of the binder added in the process (A-1), composition of the lump ore, and composition of the purchased reduced iron.

### Examples

Ores A to D (low-grade iron ore) and Ore H (high-grade iron ore) listed in Table 1 were prepared as raw material for iron ore pellets. Table 1 lists the composition (mass %) of each iron ore. Bentonite containing, in mass %, 3% CaO, 60% SiO₂, 15% Al₂O₃, and 3% MgO was prepared as the binder.

Limestone containing, in mass %, 53% CaO, 1% or less SiO₂, 1% or less Al₂O₃, and 1% MgO was prepared as the auxiliary material.

TABLE 1
(mass %)

| | | | | | | Water of | |
|---|---|---|---|---|---|---|---|
| Ore ID | T•Fe | CaO | SiO₂ | Al₂O₃ | MgO | crystallization | Remarks |
| Ore A | 60.8 | 0.79 | 3.93 | 2.08 | 0.08 | 5.9 | Low-grade |
| Ore B | 57.1 | 0.99 | 4.94 | 3.54 | 0.12 | 6.4 | |
| Ore C | 62.2 | 0.71 | 3.53 | 2.21 | 0.13 | 4.1 | |
| Ore D | 56.0 | 1.03 | 4.90 | 2.90 | 0.10 | 11.6 | |
| Ore H | 67.8 | 0.37 | 1.87 | 0.01 | 0.00 | 1.4 | High-grade |

Iron ore pellets were produced from each iron ore of Ores A to D and H. First, 300 kg of each iron ore was prepared and ground in a ball mill to obtain corresponding iron ore powders. Bentonite was added to each iron ore powder in the amounts (mass %) listed in Table 2 relative to the amount of iron ore powder, and limestone was further added so that the basicity was 0.2. Each mixture was mixed at 20 rpm for 3 min using a concrete mixer. Next, the mixed raw material was placed in a 1.2 m diameter pelletizer and granulation was carried out while adding water. Pellet particles of 9.5 mm to 12 mm were collected and rolled in a pelletizer for another 10 min to obtain green pellets. The green pellets were held in an electric furnace at 1200° C. to 1350° C. for 25 min to produce iron ore pellets.

TABLE 2

| | Bentonite content | | | | | | | | |
|---|---|---|---|---|---|---|---|---|---|
| | (mass %) | | | | | | | | |
| | Low- | High- | Iron ore pellet mix ratio | | | | | | |
| | grade | grade | (—) | | | | | S1 | S2 |
| No. | pellets | pellets | Ore A | Ore B | Ore C | Ore D | Ore H | (kg/t) | (kg/t) |
| 1 | 2 | 1.5 | 0.2 | — | — | — | 0.8 | 146.0 | 55.4 |
| 2 | 2 | 1.5 | 0.6 | — | — | — | 0.4 | 146.0 | 55.4 |
| 3 | 2 | 1.5 | 1.0 | — | — | — | 0.0 | 146.0 | — |
| 4 | 2 | 1.5 | — | 0.2 | — | — | 0.8 | 202.9 | 55.4 |
| 5 | 2 | 1.5 | — | 0.6 | — | — | 0.4 | 202.9 | 55.4 |
| 6 | 2 | 1.5 | — | 1.0 | — | — | 0.0 | 202.9 | — |
| 7 | 2 | 1.5 | — | — | 0.2 | — | 0.8 | 137.9 | 55.4 |
| 8 | 2 | 1.5 | — | — | 0.6 | — | 0.4 | 137.9 | 55.4 |
| 9 | 2 | 1.5 | — | — | 1.0 | — | 0.0 | 137.9 | — |
| 10 | 2 | 1.5 | — | — | — | 0.2 | 0.8 | 199.0 | 55.4 |
| 11 | 2 | 1.5 | — | — | — | 0.8 | 0.2 | 199.0 | 55.4 |
| 12 | 2 | 1.5 | — | — | — | 1.0 | 0.0 | 199.0 | — |
| 13 | 6 | 1.5 | 0.2 | — | — | — | 0.8 | 211.8 | 55.4 |
| 14 | 6 | 1.5 | 0.6 | — | — | — | 0.4 | 211.8 | 55.4 |
| 15 | 6 | 1.5 | 1.0 | — | — | — | 0.0 | 211.8 | — |
| 16 | 6 | 1.5 | — | 0.2 | — | — | 0.8 | 273.0 | 55.4 |
| 17 | 6 | 1.5 | — | 0.6 | — | — | 0.4 | 273.0 | 55.4 |
| 18 | 6 | 1.5 | — | 1.0 | — | — | 0.0 | 273.0 | — |
| 19 | 6 | 1.5 | — | — | 0.2 | — | 0.8 | 202.2 | 55.4 |
| 20 | 6 | 1.5 | — | — | 0.6 | — | 0.4 | 202.2 | 55.4 |
| 21 | 6 | 1.5 | — | — | 1.0 | — | 0.0 | 202.2 | — |
| 22 | 6 | 1.5 | — | — | — | 0.2 | 0.8 | 270.5 | 55.4 |
| 23 | 6 | 1.5 | — | — | — | 0.6 | 0.4 | 270.5 | 55.4 |
| 24 | 6 | 1.5 | — | — | — | 1.0 | 0.0 | 270.5 | — |
| 25 | 6 | 1.5 | — | 0.8 | — | — | 0.2 | 273.0 | 55.4 |
| 26 | 6 | 1.5 | — | — | — | 0.9 | 0.1 | 270.5 | 55.4 |

The iron ore pellets obtained as described above were charged into an electric furnace in the proportions listed in Table 2, and reduced iron was obtained by flowing gas having a volume ratio CO:H₂:CO₂:N₂=8:40:7:45 at 400° C. to 850° C. for 340 min. Reduced iron obtained by reducing iron ore pellets made from the low-grade Ores A to D is the “first reduced iron” and reduced iron obtained by reducing iron ore pellets made from the high-grade Ore H is the “second reduced iron”. Table 2 lists the mix ratio of iron ore pellets as raw material for reduced iron, the slag ratio S1 of the first reduced iron, and the slag ratio S2 of the second reduced iron.

The obtained reduced iron was charged into an SAF and melted. The basicity of the slag formed during melting, that is, the CaO/SiO₂ weight ratio, was adjusted to 1.2 by adding CaO as flux. The SAF used was a 100 kg test furnace. Table 3 lists W1, W2, S1, S2, S3, and total slag ratio.

TABLE 3

| | | | | | | Total | Electrical | |
|---|---|---|---|---|---|---|---|---|
| | | | | | | slag | power | |
| | W1 | W2 | S1 | S2 | S3 | ratio | efficiency | |
| No. | (—) | (—) | (kg/t) | (kg/t) | (kg/t) | (kg/t) | (%) | Remarks |
| 1 | 0.2 | 0.8 | 146.0 | 55.4 | 38.4 | 111.9 | 44 | Comparative Example |
| 2 | 0.6 | 0.4 | 146.0 | 55.4 | 62.3 | 172.0 | 61 | Example |
| 3 | 1.0 | 0.0 | 146.0 | — | 87.3 | 233.3 | 55 | Example |
| 4 | 0.2 | 0.8 | 202.9 | 55.4 | 42.1 | 127.0 | 48 | Comparative Example |
| 5 | 0.6 | 0.4 | 202.9 | 55.4 | 74.7 | 218.7 | 68 | Example |
| 6 | 1.0 | 0.0 | 202.9 | — | 110.7 | 313.6 | 77 | Example |
| 7 | 0.2 | 0.8 | 137.9 | 55.4 | 36.8 | 108.7 | 38 | Comparative Example |
| 8 | 0.6 | 0.4 | 137.9 | 55.4 | 57.4 | 162.3 | 62 | Example |
| 9 | 1.0 | 0.0 | 137.9 | — | 78.9 | 216.8 | 60 | Example |
| 10 | 0.2 | 0.8 | 199.0 | 55.4 | 43.6 | 127.7 | 45 | Comparative Example |
| 11 | 0.8 | 0.2 | 199.0 | 55.4 | 97.2 | 267.5 | 72 | Example |
| 12 | 1.0 | 0.0 | 199.0 | — | 116.3 | 315.3 | 74 | Example |
| 13 | 0.2 | 0.8 | 211.8 | 55.4 | 47.0 | 133.7 | 48 | Comparative Example |
| 14 | 0.6 | 0.4 | 211.8 | 55.4 | 88.8 | 238.0 | 66 | Example |
| 15 | 1.0 | 0.0 | 211.8 | — | 132.7 | 344.5 | 70 | Example |
| 16 | 0.2 | 0.8 | 273.0 | 55.4 | 50.9 | 149.8 | 49 | Comparative Example |
| 17 | 0.6 | 0.4 | 273.0 | 55.4 | 102.3 | 288.3 | 76 | Example |
| 18 | 1.0 | 0.0 | 273.0 | — | 159.0 | 432.0 | 40 | Comparative Example |
| 19 | 0.2 | 0.8 | 202.2 | 55.4 | 45.3 | 130.0 | 40 | Comparative Example |
| 20 | 0.6 | 0.4 | 202.2 | 55.4 | 83.4 | 226.9 | 63 | Example |
| 21 | 1.0 | 0.0 | 202.2 | — | 123.3 | 325.5 | 72 | Example |
| 22 | 0.2 | 0.8 | 270.5 | 55.4 | 52.9 | 151.3 | 55 | Example |
| 23 | 0.6 | 0.4 | 270.5 | 55.4 | 107.3 | 291.8 | 70 | Example |
| 24 | 1.0 | 0.0 | 270.5 | — | 165.5 | 436.0 | 30 | Comparative Example |
| 25 | 0.8 | 0.2 | 273.0 | 55.4 | 130.0 | 359.4 | 58 | Example |
| 26 | 0.9 | 0.1 | 270.5 | 55.4 | 150.6 | 399.6 | 60 | Example |

### [Current Efficiency Measurement]

The temperature of the reduced iron was raised to 1700° C. and melted in the SAF to check the electrical energy consumed. The ratio of a calculated theoretical energy required for heating and melting compared to the actual electrical energy input was determined as electrical power efficiency, and the results are listed in Table 3. In operation, the electrical power efficiency is preferably 50% or more. The electrical power efficiency is more preferably 70% or more.

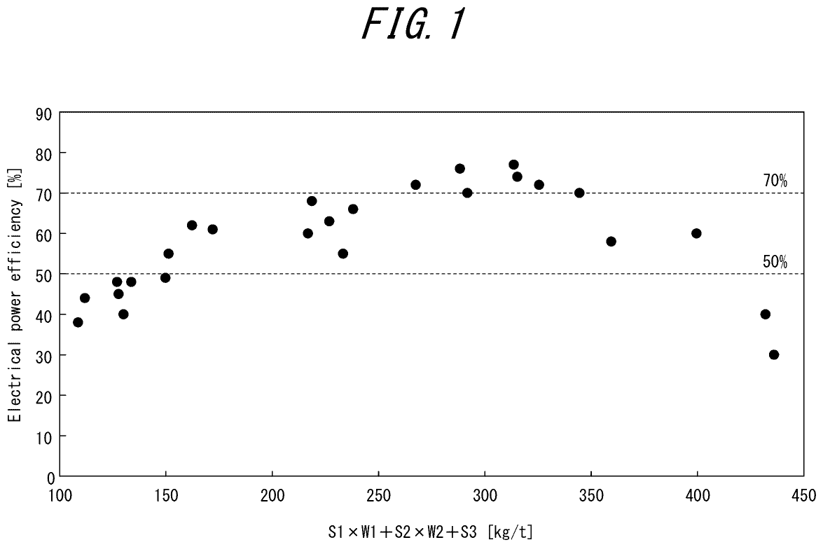

FIG. 1 illustrates the relationship between the total slag ratio in the SAF and electrical power efficiency in each case. It can be confirmed that by adjusting the total slag ratio in the SAF to be in the range of Expression (1), a high current efficiency of 50% or more is obtainable. Further, it can be seen that particularly when the slag ratio is in the range of Expression (2), the current efficiency is 70% or more, which is more suitable. In contrast, for comparative examples where the slag ratio was outside the range of Expression (1), the electrical power efficiency was below 50%, suggesting that the operation was inefficient. From the above, the effects of the present disclosure are clear.

### INDUSTRIAL APPLICABILITY

According to the method of producing hot metal, high energy efficiency can be achieved in the melting process when producing reduced iron from iron ore in a solid-reducing furnace and melting the reduced iron in a submerged arc furnace to produce hot metal.

1. A method of producing hot metal, the method comprising:
an iron ore preparation process (A) comprising a process (A-1) of preparing first iron ore pellets produced from low-grade iron ore having a total Fe content of 63 mass % or less, an optional process (A-2) of preparing second iron ore pellets produced from high-grade iron ore having a total Fe content exceeding 63 mass %, and an optional process (A-3) of preparing lump ore;
a reduced iron preparation process (B) comprising a process (B-1) of producing first reduced iron from the first iron ore pellets, an optional process (B-2) of producing second reduced iron from the second iron ore pellets, an optional process (B-3) of producing third reduced iron from the lump ore, and an optional process (B-4) of preparing a pre-produced fourth reduced iron; and
a melting process (C) of melting the first reduced iron and optionally any of the second reduced iron, the third reduced iron, and the fourth reduced iron in a submerged arc furnace to obtain hot metal, while adding flux to adjust basicity of molten slag formed on the hot metal, wherein the following Expression (1) is satisfied,
$$150. \leq S 1 \times W 1 + S 2 \times W 2 + S 3 \leq 400. \qquad ( 1 )$$
where
S1 is slag ratio, in kg/t, of the first reduced iron,
W1 is mix ratio of the first reduced iron,
S2 is average slag ratio, in kg/t, of the second, third, and fourth reduced iron,
W2 is total mix ratio of the second, third, and fourth reduced iron, and
S3 is amount of the flux, in kg/t, added in the melting process (C).

2. The method of producing hot metal according to claim 1, wherein one or more selected from the group consisting of S1, W1, S2, W2, and S3 are intentionally set to satisfy Expression (1).

3. The method of producing hot metal according to claim 2, wherein one or both of S1 and S3 are intentionally set to satisfy Expression (1).

4. The method of producing hot metal according to claim 2, wherein the setting of S1 is performed by setting one or more conditions selected from composition of the low-grade iron ore used in the process (A-1) and type and mix ratio of binder and auxiliary material added in the process (A-1).

5. The method of producing hot metal according to claim 1, further satisfying the following Expression (2)
$$250. \leq S 1 \times W 1 + S 2 \times W 2 + S 3 \leq 350. . \qquad ( 2 )$$

6. The method of producing hot metal according to claim 5, wherein one or more selected from the group consisting of S1, W1, S2, W2, and S3 are intentionally set to satisfy Expression (2).

7. The method of producing hot metal according to claim 6, wherein one or both of S1 and S3 are intentionally set to satisfy Expression (2).

8. The method of producing hot metal according to claim 6, wherein the setting of S1 is performed by setting one or more conditions selected from composition of the low-grade iron ore used in the process (A-1) and type and mix ratio of binder and auxiliary material added in the process (A-1).

9. The method of producing hot metal according to claim 1, wherein the flux is added so that the basicity, CaO/SiO₂, of the molten slag is from 1.0 to 1.3.

10. The method of producing hot metal according to claim 3, wherein the setting of S1 is performed by setting one or more conditions selected from composition of the low-grade iron ore used in the process (A-1) and type and mix ratio of binder and auxiliary material added in the process (A-1).

11. The method of producing hot metal according to claim 7, wherein the setting of S1 is performed by setting one or more conditions selected from composition of the low-grade iron ore used in the process (A-1) and type and mix ratio of binder and auxiliary material added in the process (A-1).

12. The method of producing hot metal according to claim 2, wherein the flux is added so that the basicity, CaO/SiO₂, of the molten slag is from 1.0 to 1.3.

13. The method of producing hot metal according to claim 3, wherein the flux is added so that the basicity, CaO/SiO₂, of the molten slag is from 1.0 to 1.3.

14. The method of producing hot metal according to claim 4, wherein the flux is added so that the basicity, CaO/SiO₂, of the molten slag is from 1.0 to 1.3.

15. The method of producing hot metal according to claim 5, wherein the flux is added so that the basicity, CaO/SiO₂, of the molten slag is from 1.0 to 1.3.

16. The method of producing hot metal according to claim 6, wherein the flux is added so that the basicity, CaO/SiO₂, of the molten slag is from 1.0 to 1.3.

17. The method of producing hot metal according to claim 7, wherein the flux is added so that the basicity, CaO/SiO₂, of the molten slag is from 1.0 to 1.3.

18. The method of producing hot metal according to claim 8, wherein the flux is added so that the basicity, CaO/SiO₂, of the molten slag is from 1.0 to 1.3.

19. The method of producing hot metal according to claim 10, wherein the flux is added so that the basicity, CaO/SiO₂, of the molten slag is from 1.0 to 1.3.

20. The method of producing hot metal according to claim 11, wherein the flux is added so that the basicity, CaO/SiO₂, of the molten slag is from 1.0 to 1.3.
